(19) United States
(12) Patent Application Publication
(10) Pub. No.: US 2005/0013439 A1
(43) Pub. Date: Jan. 20, 2005

(54) Method for controlling access to specific services from a broadcaster

(76) Inventor: Jean-Francois Collet, Divonne-Les-Bains (FR)

Correspondence Address: HARNESS, DICKEY & PIERCE, P.L.C., P.O. BOX 8910, RESTON, VA, 20195, US

(21) Appl. No.: 10/496,299

(22) PCT Filed: Nov. 20, 2002
(86) PCT No.: PCT/IB02/04861

(30) Foreign Application Priority Data
Nov. 21, 2001 (CH) 2143/01

(51) Int. Cl. H04K 1/00

(52) U.S. Cl. 380/270

(57) ABSTRACT

The aim of this invention is to propose a method allowing specific services to be received by a user A from a broadcaster in which this user is not initialised. So, this invention refers to an access control method of a broadcast by a broadcaster B of specific services ciphered by control-words CW, the access rights DB to these services being managed by an access control centre CAB, these rights DB, having a transmission key TB that allows the control-words CW to be deciphered, this broadcast being received by a mobile apparatus A connected to a security unit SM which includes a unique identification number UA and a security key KA for protected information transmission, this apparatus A being linked to a telephony operator B and initially registered in another access control centre CAA, this method consists of: transmitting by the provider B a description of services on the apparatus A, transmitting by the apparatus A, the request to subscribe to this service to the operator B, the request to this service and the unique identification number UA originating from the apparatus A, transmitting this request to the access control centre CAB, transmitting through the access control centre CAB the access right DB and the unique number UA to the access control centre CAA, composing at the access control centre CAA a message EMM containing the access right DB ciphered by the security key KA, transmitting to the operator B this message so that it be transmitted to the apparatus A, decoding this message EMM by the security unit SM by means of the security key KA and storing the transmission key TB and the access right DB to the service in the security unit SM, deciphering the control-words CW of the specific service in the security unit SM thanks to the transmission key TB.

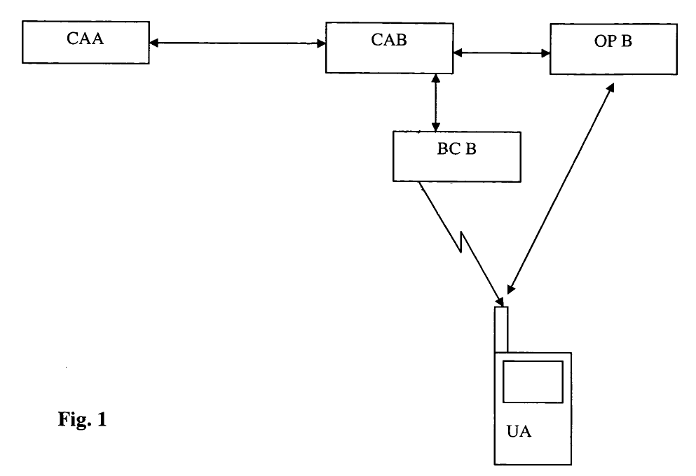

This application is the national phase under 35 U.S.C. § 371 of PCT International Application No. PCT/IB02/04861 which has an International filing date of Nov. 20, 2002, which designated the United States of America and which claims priority on Swiss Patent Application number CH 2143/01 filed Nov. 21, 2001, the entire contents of which is hereby incorporated herein by reference.

### FIELD OF THE INVENTION

This invention is in the field of access control to broadcasted services, in particular when a user moves among several networks.

### BACKGROUND OF THE INVENTION

On the telecommunications networks of the mobile telephone type, the users can move themselves from a zone covered by their home operator towards a zone covered by a third operator thanks to roaming agreements between operators such as the GSM norm defines. When a user connects to a third network, a complex verification procedure is initiated in order to determine the rights of this user. This procedure is well known and used from the moment one wishes to take advantage of the roaming function.

An example of this authentication process is described in the document U.S. Pat. No. 5,940,512 in which a mobile terminal transmits a request to a roaming operator with its unique number (MSN). This operator transmits an authentication request to the home operator of this terminal thanks to the unique number MSN. In return, the home operator sends to the roaming operator the authentication key of the terminal concerned, a key that will allow the mobile terminal to be authenticated.

The mobile phone has other applications added to offer the clientele attractive functions such as transmitting music or video for example, or stock exchange or meteorological information. We will break down the management of these services as follows:
The contents provider (broadcast network) that proposes these additional services and broadcast them by means such as radio waves. This broadcast is unidirectional.
The operator of mobile phone (communication network) whose characteristic is to establish a bi-directional connection with the phone.
The conditional access operator who delivers the authorization element for access to the services transmitted by the contents provider. There is thus a close connection between the two previously mentioned operators on the one hand to transmit the deciphering keys to the users and the cipher keys to the provider to assure the synchronism between ciphering and deciphering.

It should be noted that these operators can be the same commercial entity.

These services are subject to a subscription, or to a payment for each use. The digital flow is ciphered and managed by a system that belongs to the contents provider. When the user leaves the broadcast area of this provider, he no longer has access to these services because the management of the keys and the rights in the security modules are specific to this contents provider. Even if equivalent services are available by another content provider, he will not be able to gain access. This can restrain subscription to additional services when the user knows that these services will be inaccessible out of the area of this content provider.

In ciphered contents broadcasting, one can distinguish two types of messages:
The ECM, which is a ciphered message that contains the description of the service and a control-word (CW) that is the key to decipher the contents of the ciphered service. These ECM can be deciphered by a smart card if it has the transmission key.
The EMM is a ciphered message that loads the right relating to a product as well as the transmission key to decipher the ECM. The EMM belong to the access control system CA of the operator because each operator wants to keep control of this sensitive part.

According to the example in the document U.S. Pat. No. 5,940,512, knowing the secret key of the mobile terminal is not of any interest because the additional service is ciphered according to keys common to all the terminals. This kind of specific service differs from a telephony service in the sense that it is essentially unidirectional and it is not possible to use the secret key of each user to cipher these services. Furthermore, it is not desirable that the secret keys of all the users leaving their home operator be distributed towards the other operators.

### SUMMARY OF THE INVENTION

An aim of an embodiment of the invention is to propose a method that allows maintaining access to these specific services in spite of leaving the broadcast area of his home content provider.

An embodiment of this invention refers to an access control method of a broadcast by a provider B of specific services ciphered by control-words CW. The access rights DB to these services are managed by an access control centre CAB. The rights DB, include a transmission key TB that allows the control-words CW to be deciphered. The broadcast is received by a mobile apparatus A connected to a security unit SM which includes a unique identification number UA and a security key KA for protected information transmission. The apparatus A is linked to a telephony operator B and is initially registered in another access control centre CAA, for reception of specific services.

The method of this embodiment includes:
transmitting by the provider B a description of services on the apparatus A,
transmitting by the apparatus A, the request to subscribe to this service to the operator B, the request to this service and the unique identification number UA originating from the apparatus A,
transmitting this request to the access control centre CAB,
transmitting through the access control centre CAB the access right DB and the unique number UA to the access control centre CAA,
composing at the access control centre CAA a message EMM containing the access right DB ciphered by the security key KA,
transmitting to the operator B this message so that it be transmitted to the apparatus A,
decoding this message EMM by the security unit SM by means of the security key KA and storing the transmission key TB and the access right DB to the service in the security unit SM,
deciphering the control-words CW of the specific service in the security unit SM thanks to the transmission key TB.

Thus, in this embodiment, it is only the operator A who can transmit a message that can update a right in the security unit of user A thanks to the bi-directional connection with user A. This allows keeping track of the transaction for invoicing the service.

Furthermore, according to a first embodiment, the security unit SM of the user apparatus A allowing access to the network of the telephony operator A, also acts as the access control to specific services. The ciphering device/element/way and updating of this unit are managed by the operator A by a key KA ensuring the transmission. In this case, the access control centre CAA transmits the message EMM before its ciphering by the key KA to the operator A who only disposes of this key. The access control centre CAA transmits this message with the unique identification number UA.

According to another embodiment, the security unit SM is dedicated to the specific services and the transmission channel of the operator A only act as transfer path to this unit. In this case, the key KA is managed by the access control centre CAA. In fact, the access control centre CAB does not dispose of the key to cipher a protected message for the security unit of the user A and that is why this message is ciphered by the access control centre CAA.

By implementing a common algorithm for the ciphering of the contents based on control-words CW and a common standard for the transmission key as well as for the description of the service and of the corresponding right, it is possible to propose specific services by different operators. Thus, the ECM messages according to an embodiment of the invention contain a common part (standard) to each operator and a private part for specific applications to each conditional access system (CA).

The data exchanged between the access control centres CAA and CAB are preferably ciphered.

According to an embodiment of the invention, the specific services are broadcasted by the telephone operator himself through standard mobile telephone channels. He therefore fulfils the function of broadcaster, access control centre and operator. In this configuration data services are proposed such as stock exchange, weather forecast or road traffic information. Those data are advantageously transmitted by messages SMS.

According to another embodiment of the invention, the specific services are transmitted through a different channel than the mobile telephony, by a suitable receiver. This is especially the case of the broadcast of music or other digital data on channels different than those used by the telephony. These broadcast channels by definition do not have a return channel for a dialogue between the access control centre and the receiver.

This is why the management of a user is done through the use of the mobile telephony channel that transit the data of the user, also using data to identify him. Inversely, this channel allows transmission of the rights containing the transmission key, and inversely allows to transmit the services consumption for accounting. The digital receiver of the ciphered contents transmits the messages ECM containing the deciphering keys towards the security unit. Thanks to the transmission key TB, these messages are deciphered and the keys returned to the receiver to decipher the contents.

### BRIEF DESCRIPTION OF THE DRAWINGS

Further advantages, features and details of the invention will become evident from the description of illustrated exemplary embodiments given hereinbelow and the accompanying drawing, which is given by way of illustration only and thus is not limitative of the present invention.

The sole FIGURE is illustrated as a non-limitative example, and depicts a block diagram showing the different elements during a displacement of a user towards a broadcast zone of another operator.

### DETAILED DESCRIPTION OF THE PREFERRED EMBODIMENTS

In the FIGURE, the home access control centre CAA of the user A is illustrated which disposes of the way/device/element to update the rights in the security unit SM of apparatus A.

The access control centre CAB works in close collaboration with the broadcaster BC B for the broadcast of specific services, such as music or digital data. This data flow is ciphered by control-words CW that act as ciphering keys during a given time (for example 10 seconds). These control-words are contained in a message ECM ciphered by a transmission key TB generally produced by the control centre CAB. This method is well known and has been used for a long time in pay TV transmission.

Once the transmission key TB is in the security unit, the ECM messages are deciphered thanks to this transmission key TB and the control-words CW are returned to the receiver to decipher the digital flow.

When the user A wishes to gain access to the service proposed by the broadcaster BC B, the request is transmitted from the user A by the operator OP B who disposes of a communication channel with this user. This request is then transmitted towards the control centre CAB with the indications necessary to identify this user. This information is, among others, his unique address UA that allows identifying the user A with certainty. As the user A is not known by the control centre CAB, a connection is established with the control centre CAA to prepare a message EMM whose characteristics are determined by the home control centre CAA.

For that purpose the control centre CAB transmits the description of the access right to the desired service containing the transmission key TB. The control centre CAA composes the EMM message which includes the corresponding right, this message being ciphered by a security key KA belonging to the user A. This message is sent to the operator B to be transmitted to the user A.

Once the EMM message is deciphered by the key KA, and the right DB is stored in the security unit of the user A, it is possible to receive the specific service thanks to the use of the transmission key TB.

It should be noted that the proposal of the services can be sent by the operator B or by the broadcaster B. The return channel is on the other hand limited to the operator B because the broadcaster does not have means to establish a direct connection with the user. Nevertheless, if such a channel had to be available, the control of the specific service could be returned to the broadcaster B instead of to the operator B.

This method is not limited to the broadcast of specific services outside the broadcast zone of the home broadcaster A. For example, it can also apply when the access control to this service is managed by another control centre CAB as the one to which the user A is registered. In this case, the request passes through the operator A and his access control centre CAA, then it is transmitted to the access control centre CAB. The latter returns the right to the requested service at the access control centre CAA then to the user A through the operator A.

With an additional subscription, it is possible for the operator A to propose services provided by other operators (B for example) thanks to the method of an embodiment(s) of the invention.

According to a particular form of access to these specific services, one can imagine that the transmission key TB must be changed regularly, for example every hour, the user being debited for each hour of consumption. The apparatus of the user can automatically generate an order if the receiver is always adjusted to the specific service. The operation described above is then carried out without the user realising and the new transmission key TB′ replaces the old one. The operator B can ask the operator A with each updating of the transmission key TB for an EMM. This will be returned to the user either by the broadcast signal or by the phone network.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. Control access method by a broadcaster services ciphered by control-words, wherein access rights to the services are managed by an access control centre, the rights including a transmission key for allowing the control-words to be deciphered, and wherein a broadcast is receivable by a mobile apparatus locally connected to a security unit including a unique identification number and a security key for protected information transmission, the mobile apparatus being linked to a telephony operator and registered with another access control centre for reception of at least one service, the method comprising:
transmitting by the broadcaster, a description of at least one services for the mobile apparatus;
transmitting by the mobile apparatus, a request to subscribe to at least one service to the telephony operator, the request and a unique identification number originating from the mobile apparatus;
transmitting the request to the access control centre;
transmitting, through the access control centre, an access right and the unique number to the access the another control centre;
composing at the another access control centre, a message containing the access right ciphered by the security key;
transmitting, to the operator, the message for transmission -to the mobile apparatus;
decoding the message, by the security unit, using the security key and storing the transmission key and the access right to the service in the security unit; and
deciphering the control-words of the at least one service in the security unit using the transmission key.

2. Control access method according to claim 1, wherein a specific service proposal is transmitted by the operator.

3. Control access method according to claim 1, wherein a specific service proposal is transmitted by the broadcaster.

4. Control access method according to claim 1 , wherein the security unit is common to security operations of the operator and to security operations of the broadcaster.

5. Control access method according to claim 1, wherein the security unit is dedicated to the broadcaster security operations.

6. Control access method according to one of claim 1, wherein a broadcast of the mobile apparatus is different from a broadcast area of the broadcaster and wherein the respective access control centre and another access control centre are different.

7. Control access method according to claim 1. wherein the data exchanged between the mobile apparatus and the operator are ciphered.

8. Control access method according to claim 1, wherein a ciphering system, a description of a service and of a corresponding right, and ciphering of a message including the control words by a transmission keys are common for all the broadcasters.

9. Control access method according to claim 7, wherein a ciphering system, a description of a service and of a corresponding right, and ciphering of a message including the control words by a transmission key, are common for all the broadcasters.

10. Control access method according to claim 2, wherein the security unit is common to security operations of the operator and to security operations of the broadcaster.

11. Control access method according to claim 2, wherein the security unit is dedicated to the broadcaster security operations.

12. Control access method according to claim 3, wherein the security unit is common to security operations of the operator and to security operations of the broadcaster.

13. Control access method according to claim 3, wherein the security unit is dedicated to the broadcaster security operations.

14. Control access method according to claim 6, wherein the data exchanged between the mobile apparatus and the operator are ciphered.

15. Control access method according to claim 14, wherein a ciphering system, a description of a service and of a corresponding right, and ciphering of a message including the control words by a transmission key, are common for all the broadcasters.
